(19) United States
(12) Patent Application Publication
(10) Pub. No.: US 2016/0230132 A1
(43) Pub. Date: Aug. 11, 2016

(54) ICEWINE BRANDY AND PROCESS OF PRODUCTION THEREOF

(71) Applicant: John Chung Nan Chang, Richmond (CA)

(72) Inventor: John Chung Nan Chang, Richmond (CA)

(21) Appl. No.: 15/018,794

(22) Filed: Feb. 8, 2016

Related U.S. Application Data
(60) Provisional application No. 62/113,433, filed on Feb. 7, 2015.

(51) Int. Cl. C12G 1/02; C12G 1/00

(52) U.S. Cl. CPC C12G 1/02; C12G 1/00

(57) ABSTRACT

A process to produce an Icewine brandy comprises harvesting frozen grapes and pressing them to produce a concentrated juice extract, low temperature fermenting the concentrated juice extract with yeast to form a fermented extract, filtering the fermented extract and finally concentrating the fermented extract by distillation to produce an Icewine brandy.

### CROSS-REFERENCE TO RELATED APPLICATION

This application claims priority to U.S. Provisional Patent Application No. 62/113,433, filed Feb. 7, 2015, the disclosure of which are hereby incorporated herein by reference in its entirety for all purposes.

### FIELD OF THE INVENTION

The present invention relates generally to methods of producing a fermented, distilled beverage.

### BACKGROUND

Icewine is wine made from grapes that have been left to freeze naturally on the vine. Icewine, to be accorded that name, must be made from approved grape varieties with the most popular being Vidal Blanc, Riesling and Cabernet Franc.

Grapes are grown and generally netted in the Autumn, as protection from being eaten by birds. Grapes are left on the vine until a sustained temperature of −8° C. or lower is reached (sometime between December and February). During the time between the end of the growing season and harvest, the grapes dehydrate, concentrating the juices and creating the characteristic complexities of Icewine.

Grape growers and wineries carefully watch the weather, looking for an optimum stretch of temperatures between −10° C. and −12° C. This range will produce very sweet juice in the range of 35° Bx to 39° Bx (degrees Brix, which is a measurement of sugar). Typically, a period of at least six hours is needed to harvest and press the grapes—usually during the night.

While still frozen, the harvested grapes are pressed, leaving most of the water behind as ice. Only a small amount of concentrated juice is extracted. Juice yields for Icewine grapes are much lower than for table wines—only 15% of the expected yield for grapes harvested for table wines.

While the berries are frozen as hard as marbles, the juice is pressed out. Since a grape contains eighty percent water, the action of pressing allows much of this water to be left behind as shards of ice, while small amounts of very concentrated juice, very sweet and high in acidity, drip slowly from the press.

Once pressed, the Icewine is transferred into a fermentation tank where yeast is added to begin the fermentation process. Unlike table wines where fermentation happens relatively quickly with the yeast consuming sugar to product alcohol, Icewine fermentation is a slow and difficult process. This is primarily due to the high concentration of sugar. The yeast has difficulty establishing with this level of sugar and winemakers often struggle to moderate the amount of yeast in the wine. Fermentation can take anywhere from six weeks to six months depending on the wine. Once finished, the wine is filtered and then bottled.

Due to its popularity, there is a keen interest in developing other beverage products related to Icewine. It is an object of the present invention to achieve this.

### SUMMARY OF THE INVENTION

The present invention provides a brandy, produced by distillation of Icewine.

The present invention provides a process to produce an Icewine brandy comprising the following steps:

harvesting frozen grapes and pressing them to produce a concentrated juice extract;

low temperature fermenting the concentrated juice extract with yeast to form a fermented extract;

filtering the fermented extract; and

concentrating the fermented extract by distillation to produce an Icewine brandy.

Within the process of the invention, precise control is maintained over at least the following parameters: grape harvesting temperature, grape pressing pressure and temperature, fermentation temperature/time and distillation temperature/time. Using this process, and with Icewine as the starting material for the distillation process, the end product, “Icewine Brandy” provides a new and unique product, embodying natural aromas such as, without limitation and for example, honey, pineapple, apple, and peach. The natural flavours of the selected Icewine are thereby imparted to the Icewine Brandy.

These and other objects and advantages of the present invention will become more apparent to those skilled in the art upon reviewing the description of the preferred embodiments of the invention, in conjunction with the figures and examples.

A person skilled in the art will realize that other embodiments of the invention are possible and that the details of the invention can be modified in a number of respects, all without departing from the inventive concept. Thus, the following drawings, descriptions and examples are to be regarded as illustrative in nature and not limiting.

### BRIEF DESCRIPTION OF THE DRAWINGS

Embodiments of the present invention will now be described, by way of example only, with reference to the attached Figure, wherein:

FIG. 1 shows a flow chart illustrating a production process for Icewine Brandy.

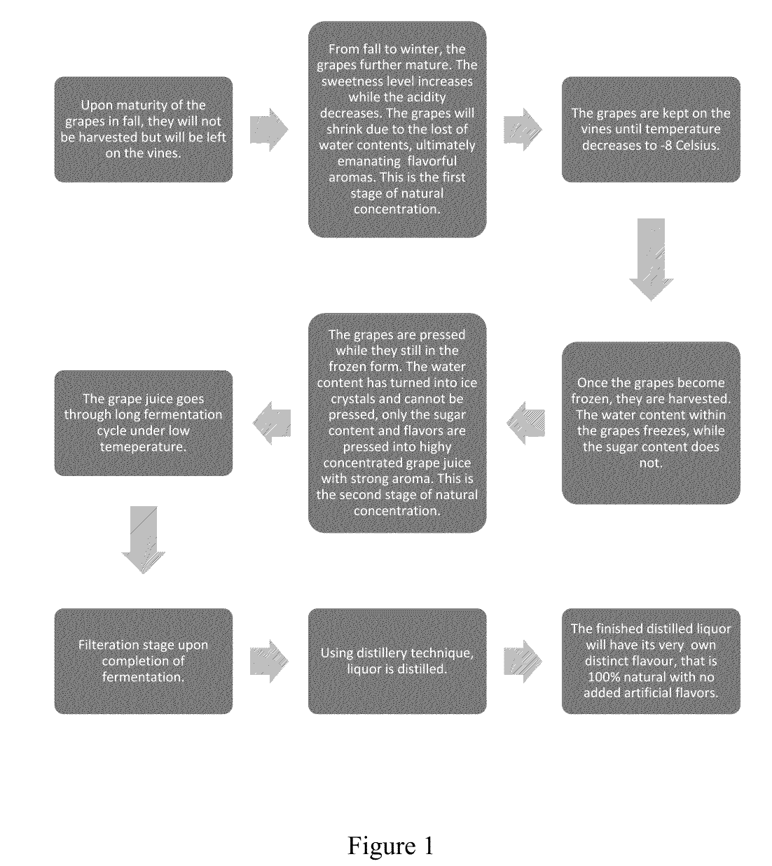

### DETAILED DESCRIPTION OF THE INVENTION

A detailed description of one or more embodiments of the invention is provided below along with accompanying figures that illustrate the principles of the invention. As such this detailed description illustrates the invention by way of example and not by way of limitation. The description will clearly enable one skilled in the art to make and use the invention, and describes several embodiments, adaptations, variations and alternatives and uses of the invention, including what we presently believe is the best mode for carrying out the invention. It is to be clearly understood that routine variations and adaptations can be made to the invention as described, and such variations and adaptations squarely fall within the spirit and scope of the invention.

In other words, the invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

The term “product” means any machine, manufacture and/or composition of matter, unless expressly specified otherwise.

The term “method” means any process, method or the like, unless expressly specified otherwise.

Each process (whether called a method or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. .section 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The term, “brandy” in general, is from the term “brandywine”, derived from Dutch brandewijn, “gebrande wijn” or “burned wine”. It is a spirit produced by distilling wine. Brandy generally contains 35-60% alcohol by volume (70-120 US proof) and is typically taken as an after-dinner drink. Some brandies are aged in wooden casks, some are coloured with caramel colouring to imitate the effect of aging, and some brandies are produced using a combination of both aging and colouring. Varieties of wine brandy can be found across the winemaking world. Among the most renowned are Cognac and Armagnac from Southwestern France.

The term Icewine refers to wine made from grapes that were frozen on the vine, before being harvested, pressed and fermented.

The term Icewine brandy, as used herein, refers to a beverage made from grapes that were frozen on the vine, before being harvested, pressed, fermented, filtered and then concentrated by distillation, in accordance with the new process of the present invention.

The invention comprises a process by which Icewine brandy is produced from frozen grapes. More specifically, within the scope of the invention, a new derivate of traditional “brandy” is produced from Icewine. The process comprises the following steps:

a) harvesting frozen grapes and pressing them to produce a concentrated juice extract;

b) low temperature fermenting the concentrated juice extract with yeast to form a fermented extract;

c) filtering the fermented extract; and

d) concentrating the fermented extract by distillation to produce an Icewine brandy.

Step One: Harvesting and Pressing Frozen Grapes

The grapes are harvested frozen in Autumn to Winter wherein extremely ripe grapes have increased sweetness, decreased acidity, and reduced moisture content (leading to shrunken appearance of grapes). Generally, grapes remain on the vine until the temperature has dropped to at least −8° C. at which time they are harvested for use in this process. Sugar and natural aromatic substances do not freeze. Further, the water content inside grapes will be frozen only after the temperature drops below −8° C., hence that temperature target.

Grapes are then pressed. Specifically, by pressing, the liquid is squeezed out, thereby obtaining a sugar-rich substance and a high concentration of natural aroma of grape juice. Preferred pressing pressure: 2-3 bar. Preferably pressing temperature is consistent with harvesting temperature as pressing follows closely with harvesting. In one aspect, grapes are pressed at 3 bar, and at a temperature of at or less than −8° C.

Step Two: Fermenting the Concentrated Juice Extract

This step is low temperature fermentation. The concentrated extract is fermented at a low temperature. In one aspect, this is below 12° C. In another aspect, this is between 10-16° C. In another aspect, this is between 11-12° C. Fermentation preferably occurs from 1-4 months. In one aspect, it extends 2-3 months. In one aspect, fermentation temperature time/temperature: 30 days, temperature below 16° C.

The high concentration of grape juice, the fermented extract, the product of this fermentation step, is then filtered. Grape wine has a unique multiple natural flavors such as honey, peach, pineapple, green apple, apricot, mango, lychee.

Step Three: Distillation

Distillation refers to the step of heating a liquid to separate components with different boiling points. While brandies are usually made from fermented fruit juices, it can be distilled from any liquid that contains sugar. All that is required is that the liquid be allowed to ferment and that the resulting mildly-alcoholic product not be heated past the boiling point of water. The low-boiling point liquids distilled from wine include almost all of the alcohol, a small amount of water, and many of the wine's organic chemicals. The process of distillation, in which the fermented liquid mixture is heated, alcohol is extracted in the form of vapour and then it is again transformed into liquid condition by cooling. Alcohol is extracted from the mixture as a compound with a lower boiling point. Alcohol contents in a pre-distilled liquid can be increased by repeated distillations, with the reduction of the total volume of liquid.

In one aspect the fermented extract of the process of the invention is distilled at a temperature less than 85° C. In another aspect, the fermented extract of the process of the invention is distilled at a temperature of from 75° C. to 87° C. The distilled alcohol content of the concentration step is from 35˜65% Icewine brandy.

In another aspect, the fermented extract of the process of the invention is distilled with temperature/time: one cycle 12 hours, temperature below 80° C.

In another aspect, the fermented extract is distilled at a temperature of less than 85° C. In a most preferred form, the fermented grapes are distilled three times (a three times distillery process), for an ending alcohol level of about 58%.

General Comments on Distillation:

Around the world, there are various national brandy varieties: grappa in Italy is made from grape skins, slivivitz in Poland is made from plums, shochu in Japan is made from rice, and bourbon in the United States is made from corn. Beer brandy is better known as Scotch whiskey. It is universally acknowledged that the finest brandies are the French cognacs that are distilled from wine.

During brandy production, a fermented liquid is boiled at a temperature between the boiling point of ethyl alcohol and the boiling point of water. The resulting vapors are collected and cooled. The cooled vapors contain most of the alcohol from the original liquid along with some of its water. To drive out more of the water, always saving the alcohol, the distillation process can be repeated several times depending on the alcohol content desired.

So, brandy is distilled from the base wine in two phases. In the first, large part of water and solids is removed from the base, obtaining so-called “low wine”, basically a concentrated wine with 28-30% ABV. In the second stage, low wine is distilled into brandy. The liquid exits the pot still in three phases, referred to as the “heads”, “heart” and “tails” respectively. The first part, the “head,” has an alcohol concentration of about 83% (166 US proof) and an unpleasant odour. The weak portion on the end, “tail”, is discarded along with the head, and they are generally mixed with another batch of low wine, thereby entering the distillation cycle again. The middle heart fraction, richest in aromas and flavors, is preserved for later maturation.

Distillation does not simply enhance the alcohol content of wine. The heat under which the product is distilled and the material of the still (usually copper) cause chemical reactions to take place during distillation. This leads to the formation of numerous new volatile aroma components, changes in relative amounts of aroma components in the wine, and the hydrolysis of components such as esters.

Brandy is usually produced in pot stills (batch distillation), but the column still can also be used for continuous distillation.

In a preferred form, the grapes used in this process are Petit Verdot and Viognier. In the preparation process of the above-described ice wine brandy, grape varieties comprising Vidal, Sauvignon Blanc, Chardonnay, Carignan, Cabernet Sauvignon, Cabernet Franc, late red honey, Beichun, Ray Commander, Pinot Noir, white feather, Riesling, Baiyaouya species in any one or more. Among them, Vidal cold resistant to cold, high acid content Riesling, ice wine can be gentle sweetness.

Apparatus. The apparatus used to distill Icewine brandy from a pressed liquid of fermented frozen grapes usually consists of a cauldron which is connected to an upright vapour tube to which alcohol vapours leave during the process of heating. Preferably, the vapour tube leads to the condenser where the complete condensation of alcohol vapours into liquid condition takes place, by means of a cold water current.

Preferably, the apparatus that is used for Icewine brandy production is usually made of copper.

Production. The technological process of Icewine Brandy production consists of four basic stages, which are:

pressing, grinding, fine cutting or crushing of frozen grapes;

fermenting or alcohol boiling—transformation of carbohydrates into alcohol and carbon dioxide (CO₂), by means of the addition of yeast;

distilling—the technological operation in which alcohol is extracted from the fermented mixture; and finally

aging the distilled product, as desired.

The taste, aroma and colour of a particular sort of Icewine brandy are developed in accordance with this process. Distillation separates alcohol through vaporization. Controlled heating temperature is very important at this point. The fermented liquid will be exposed to a gradual increase and decrease of temperature that would eventually result to condensed drops of spirits. These drops are the distilled spirits, which are purer and richer in content compared to ordinary wine. At this point, the collected Icewine brandy can then be preserved for bottling and eventually, for consumption.

While the forms of processes and compositions described herein constitute preferred embodiments of this invention, it is to be understood that the invention is not limited to these precise forms. As will be apparent to those skilled in the art, the various embodiments described above can be combined to provide further embodiments. Aspects of the present composition, method and process can be modified, if necessary, to best employ the processes and methods of the invention. These aspects are considered fully within the scope of the invention as claimed. For example, the various methods described above may omit some acts, include other acts, and/or execute acts in a different order than set out in the illustrated embodiments.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

All publications, patents and patent applications mentioned in the specification are indicative of the level of those skilled in the art to which this invention pertains. All such publications, patents and patent applications are incorporated by reference herein for the purpose cited to the same extent as if each was specifically and individually indicated to be incorporated by reference herein.

The following example illustrates preferred but non-limiting embodiments of the present invention.

### EXAMPLE

First, squeeze the grapes immediately when there are ice conditions, the grapes include sugar, acid and natural aromatic substances including liquid is squeezed out to obtain enriched sugar, acid and high concentrations of natural aromatic substances grape juice; the second is mature and frozen after leaving fruit on the vine mildew has not been contaminated, and therefore its exceptionally pure wine brewing.

After distillation of grape wine, since the flavor of the original with a coarse ore, it is stored, Chen cooked, and brewed. The storage container for, generally use the capacity of about three hundred to six hundred barrels in liters. Oak is not only due to the storage container, the material has an influence on the quality brandy, especially oak species contained in the fibers is a direct factor in the decision after Chen cooked flavor. After washing oak, grape wine is loaded at a temperature low-temperature storage. After storage, since the oak tannins work, there is a showing of a fragrant, mellow flavor. Finally, the concentration produces alcohol of 35-65% in the Icewine brandy, high concentration, and the most pure.

In the press process, the ambient temperature is maintained at −8° C. or less. To squeeze out the viscous ice grape juice, pressure is applied. Yield of a high concentration of grape juice rich in various flavor components sugar, acid and natural aromatic substances. High concentrations of grape sugar content is not less than 350 g/L, total acid content of not less than 10 g/L (in tartaric acid). The high concentration of grape juice is warmed to about 10° C., according to 1.5 wt %˜2.0 wt % add yeast culture to solution in a temperature-controlled fermentation. Slow fermentation at low temperature occurs for several weeks at about 10° C., thereby obtaining a grape wine.

The low-temperature fermentation temperature is 10° C. to about 12° C. In ice wine brewing process, slow fermentation temperature is a key step of the process, different fermentation temperatures directly affect the quality of ice wine. When the fermentation temperature was 5° C., the yeast activity is greatly inhibited, fermented wine high sugar, high acidity, low alcohol, wine uncoordinated. When the fermentation temperature greater than 12° C., as the temperature rises, fermented wine of alcohol and volatile acids significantly increased, total sugar, dry extract and amino acid content decreased, weakening the typical mellow sweet Icewine. Taken together, the ice wine fermentation temperature is ideally and preferably controlled at 10° C. to about 12° C., most preferably around 11° C.

The distillation temperature is maintained from within the range of 81° to about 84° C. As noted herein Icewine is the use of harvesting at a temperature at minus 8° C. or less, the vine naturally frozen grapes wines. Picking grapes when pressing, in the press during the outside temperature is ideally maintained at −8° C. or less, and excess water is removed due to ice crystals form, only a small amount of concentrated grape juice is frozen out of a solid, this juice is slowly fermented, so ice is a concentrate, its aroma, its alcohol content is usually around 10 degrees. The present invention is made of ice wine for distillation, and distillation is not only a process of concentration of alcohol, at the same time, but the main controller of the flavor component is the extraction and purification process. According to the principle known distillation, each of the components in a different alcohol concentration, there are certain volatile factors, that is to say the capacity of the volatile components in size with the concentration of alcohol varies (including alcohol itself). So after a high concentration of the low temperature fermentation of grape juice grape wine for distillation is a process of extraction and concentration of aroma components again, and for this reason, there is no need to add to the wine spices or other additives to increase the aroma of the wine. At the same time, this process greatly enhances the alcohol distillation, yielding a products with a more mellow taste, aroma and sweetness at the same time. In spite of the high alcohol content, there is a soft mellow taste, with no burning sensation in the mouth when drinking.

In the preparation process of the above-described ice wine brandy, the alcohol content of ice wine brandy is 56-62%.

The above distillation is in Charentes in a distillation unit. Charentes distillation is used for the second distillation, a distillation of grape wine to give crude distillation of wine of 26-29%, and then the original crude distillation secondary distillation, distillate break off both ends to give middle distillate, use second distillation to ensure the delicate aroma and higher alcohol content.

We claim:

1. A process to produce an Icewine brandy comprising the following steps:
a) harvesting frozen grapes and pressing them to produce a concentrated juice extract;
b) low temperature fermenting the concentrated juice extract with yeast to form a fermented extract;
c) filtering the fermented extract; and
d) concentrating the fermented extract by distillation to produce the Icewine brandy.

2. The process of claim 1 wherein the grapes are harvested at a temperature of at or less than −8° C.

3. The process of claim 1 wherein the grapes are pressed at between 2-3 bar.

4. The process of claim 1 wherein the grapes are pressed at between 2-3 bar and at a temperature of at or less than −8° C.

5. The process of claim 1 wherein the concentrated juice extract is, at step b) fermented at between 10-16° C.

6. The process of claim 1 wherein the concentrated juice extract is, at step b) fermented at between 10-12° C.

7. The process of claim 1 wherein the concentrated juice extract is, at step b) fermented for 2 to 3 months.

8. The process of claim 1 wherein the filtered extract is, at step c) distilled at a temperature of less than 85° C.

9. The process of claim 1 wherein the filtered extract is, at step c) distilled at a temperature of between 75-87° C.

10. The process of claim 1 wherein the Icewine brandy has an alcohol content of from 35-65%.

11. The process of claim 1 wherein the Icewine brandy has an alcohol content of from 56-62%.

12. The process of claim 1 wherein the filtered extract is, at step c) distilled three times.

13. The process of claim 1 wherein said distillation is in Charentes in a distillation unit.

14. Icewine brandy prepared from icewine grapes.

15. Icewine brandy prepared by the process of claim 1.

16. Icewine brandy prepared by the process of claim 1 wherein the grape of claim 1 is selected from the group consisting of Vidal grapes, Viognier, Sauvignon Blanc, Chardonnay, Carignan, Cabernet Sauvignon beads, Cabernet Franc, late red honey, north alcohol, Riesling, Pinot Noir, white feather, Riesling, and Baiyaouya species.

17. Icewine brandy of claim 8 wherein the grape is Viognier.

18. Icewine brandy of claim 14 prepared from a grape selected from the group consisting of Vidal grapes, Viognier, Sauvignon Blanc, Chardonnay, Carignan, Cabernet Sauvignon beads, Cabernet Franc, late red honey, north alcohol, Riesling, Pinot Noir, white feather, Riesling, and Baiyaouya species.
